(19) United States
(12) Patent Application Publication
(10) Pub. No.: US 2016/0001348 A1
(43) Pub. Date: Jan. 7, 2016

(54) Method for Producing Screws and Concrete Screw

(71) Applicant: Hilti Aktiengesellschaft, Schaan (LI)

(72) Inventors: Tobias NEUMAIER, Rankweil (AT); Corinna ACHLEITNER, Bludenz (AT); Guenterq DOMANI, Weissensberg (DE); Mark WINKLER, Hohenems (AT)

(73) Assignee: Hilti Aktiengesellschaft, Schaan (LI)

(21) Appl. No.: 14/770,396

(22) PCT Filed: Feb. 12, 2014
(86) PCT No.: PCT/EP2014/052690

§ 371 Date: Aug. 25, 2015

(30) Foreign Application Priority Data
Feb. 26, 2013 (DE) 10 2013 203 148.3

(51) Int. Cl. B21H 3/06; F16B 25/00

(52) U.S. Cl. CPC B21H 3/06; F16B 25/0026; F16B 25/0084

(57) ABSTRACT

A method for producing a concrete screw is disclosed. The lateral surface of the shaft includes, on the end of the shaft, at least one cut-out recess. A piece of rod is provided as a workpiece, at least one threaded coil is formed on the lateral surface in a thread rolling process in which two profiled rolling tools act on the workpiece, and at least one recess is formed in the lateral surface on an end area of the workpiece. The recess, when seen in the cross-section of the workpiece, is diametrically opposite an area of the workpiece free of recesses such that initially the recess is formed in the lateral surface and subsequently, the threaded coil is formed on the lateral surface of the workpiece, and at least one of the rolling tools also acts upon the end area with the recess during the thread rolling process.

This application claims the priority of International Application No. PCT/EP2014/052690, filed Feb. 12, 2014, and German Patent Document No. 10 2013 203 148.3, filed Feb. 26, 2013, the disclosures of which are expressly incorporated by reference herein.

### BACKGROUND AND SUMMARY OF THE INVENTION

The invention relates to a method for producing a screw, in particular a concrete screw, comprising a shaft and screw thread arranged on the lateral surface of the shaft, wherein at least one cut-out recess is provided in the lateral surface of the shaft on a tip of the shaft. Such a method provides that:
a piece of rod is provided as a workpiece,
at least one threaded coil is formed on the lateral surface of the workpiece in a thread rolling process, in which two profiled rolling tools, preferably on two opposing sides, act on the workpiece, and
at least one recess is formed in the lateral surface of the workpiece on an end area of the workpiece.

The invention relates further to a concrete screw. Such a concrete screw is equipped with a shaft and a screw thread arranged on the lateral surface of the shaft, wherein at least one cut-out recess is provided in the lateral surface of the shaft on the tip of said shaft.

A generic method is known from US 2011274516 A. This document teaches a method for producing a concrete screw, in which initially a screw thread is formed on a shaft, and in which subsequently grooves are milled out of the shaft by means of oblique milling wheels. The milled-out grooves, which are a reflection of the milling wheels, are bounded by sharp edges. As explained in EP 2 233 757 A2 for example, these edges can serve as cutting edges, which can widen a non-ideal cylindrical borehole when the screw is screwed, and which can therefore make it possible to insert concrete screws with a relatively large core diameter and thus with relatively high loading capacities.

The object of the invention is to disclose a method for producing screws, in particular concrete screws, which can be used to simply and inexpensively manufacture screws that can handle a load and are easy to insert, and to disclose a corresponding concrete screw.

A method according to the invention is characterized in that,
the recess, when seen in the cross-section of the workpiece, is diametrically opposite from an area of the workpiece that is free of recesses,
that initially the recess is formed in the lateral surface of the workpiece and subsequently, the threaded coil is formed on the lateral surface of the workpiece, and
that at least one of the rolling tools, preferably both rolling tools, also act on the end area of the workpiece with the recess during the thread rolling process.

A first basic idea of the invention can be seen in arranging the recesses such that at least one of the recesses, preferably all recesses, are not opposite from a corresponding recess so that the cross-section of the workpiece in the area of the recesses is asymmetrical with respect to a mirroring on the longitudinal axis of the workpiece. Accordingly, at least one of the recesses, preferably all recesses, are each opposite from an area that is free of recesses, in other words, an area without a recess, at which the workpiece is configured to be convex, in particular cylinder-segment-like, and/or projecting spherically to the outside. A further basic idea can be seen in that recesses arranged in such a way are rolled over during the thread rolling process, in other words, that at least one, preferably both opposing rolling tools also act on the immediate vicinity of the recesses.

It was surprisingly shown that, in the case of such a procedure, a deformation can occur in the area of the recesses and even in the axial direction going beyond this area, in which a formerly circular shaft cross-section with a uniform curvature is transformed into a non-round cross-section with a curvature, in particular into a cross-section, which approximates a polygonal line. Moreover, it was surprisingly shown that the resulting screws are especially easy to insert with good loading capacities. The formation of a non-round cross-section in the vicinity of the recesses can be attributed under the circumstances to the fact that the free end of the workpiece, at which at least one recess is designed to be asymmetrical, carries out a type of wobbling motion during rolling due to the asymmetrical cross-sectional design, which can possibly build up over the course of the rolling process. The good insertability, in turn, can be attributed to the fact that with the resulting cross-sectional shape in the area of the tip, a friction between the screw core and the borehole wall occurs only locally, without the capability of the screw to widen the borehole being lost.

The method according to the invention is preferably used to produce a concrete screw, i.e., a screw having a self-tapping thread, which can be screwed into a concrete substrate with the formation of a counter thread. Suitably, at least one threaded coil forms, as the case may be after a post-processing, the screw thread in the finished screw, and/or the recess in the lateral surface of the workpiece forms, as the case may be after a post-processing, the cut-out recess in the finished screw. The invention is especially suitable for producing concrete screws with a relatively thick shaft, i.e., for example for such screws, in which the ratio of the outer diameter of the screw thread to the core diameter of the shaft is 1.1 to 1.4. The workpiece and/or the screw are preferably made of a metal material.

The shaft and/or the workpiece expediently have a cylindrical lateral surface at least in sections. The tip of the shaft can be understood in particular as the end of the shaft, which is first introduced into the substrate with proper use of the screw, i.e., the area where the self-tapping screw thread begins. The lateral surface can be understood by definition as especially that outer surface that has a sleeve-like shape.

It is especially expedient that the piece of rod, from which the method according to the invention originates, has a circular cross-section. The piece of rod is preferably configured to be cylindrical, especially preferably circular cylindrical, in particular in the shape of a straight circular cylinder. This makes it possible to further reduce the manufacturing expense, in particular because an alignment of the workpiece can be dispensed with due to the high level of symmetry.

Furthermore, it is advantageous for an uneven number of recesses to be formed in the lateral surface of the workpiece, in particular at least three recesses, preferably precisely three recesses. This makes it possible to maintain the asymmetrical original shape according to the invention especially simply in terms of manufacturing for the thread rolling. Three recesses are preferably provided. Recesses with a relatively large opening can be realized hereby, which can accommodate especially well the stone dust that accrues during cutting.

If a plurality of recesses is provided, it is especially advantageous that the recesses, when seen in the cross-section of the workpiece, are arranged equidistantly. In particular, the workpiece, at least chronologically immediately before the thread rolling process, can have a rotationally symmetric cross-sectional shape, i.e., a shape in which a rotation of the cross-sectional shape around a specific angle brings the cross-sectional shape into congruence with itself. A three-fold rotational symmetry is preferably provided. The manufacturing expense can be reduced even further by this embodiment and/or the insertability and/or load-bearing capacity of the finished screw can be improved even further.

The thread rolling process is preferably a flat-die rolling process, in which two rolling dies, which are moved linearly towards each other, act as rolling tools on the workpiece. This makes an especially favorable and efficient process control possible and the effect in accordance with the invention, whereby a non-round cross-section is generated in sections during thread rolling, can be especially pronounced. The two rolling tools act, according to the invention on diametrically opposite sides of the workpiece. The rolling tools put the workpiece into motion in a rolling rotational direction of the workpiece.

An expedient embodiment is that the recess is introduced in the lateral surface of the workpiece by forming, in particular cold forming, i.e., by a non-machining manufacturing process, in which the workpiece is permanently modified plastically in terms of its shape while retaining its mass and cohesion. This type of non-machining forming process can be integrated especially simply into the manufacturing sequence of the screw and be combined with other steps. In addition, in certain circumstances in the case of a cold forming process, a local strain hardening can occur which can further strengthen the mechanism producing the non-round tip shape.

According to the invention, the recess is introduced in an end area of the workpiece in the lateral surface of the workpiece. It is expedient that the recess be open toward the front side of the workpiece. A design of the recess that is open towards the front can further support the effect in accordance with the invention, whereby a non-round cross-section is generated in sections during thread rolling. Moreover, this design makes an especially simple fabrication using a die possible. Accordingly, it is especially advantageous that the cut-out recess is open towards the front side of the screw.

The recess and therefore the cut-out recess are situated preferably in the tip region of the workpiece or the screw.

It is advantageous that the recess be introduced by compression forming, in particular by impact extrusion. This can be advantageous with respect to the manufacturing expense. By definition, the compression forming process is understood to be forming with predominant compressive stress. To introduce the recess, the workpiece is pressed appropriately into or by a die.

It is especially expedient that the screw have a screw head that is widened with respect to the shaft. This screw head can be used for rotationally fixed coupling with an insertion tool. The screw head can have a polygonal structure for example, preferably an external hexagon, for rotationally fixed coupling with an insertion tool.

It is advantageous in this connection that the workpiece be compressed and a thickening be thereby fabricated at the end. The thickening at the end can be formed in order to form the screw head of the finished screw or to form the screw head immediately.

The manufacturing expense can be reduced by the thickening at the end being fabricated or formed at the same time that the recess is introduced in the lateral surface of the workpiece. To this end, an axial force can be applied with a punch on the end of the workpiece, where the thickening is formed, wherein the axial force drives the workpiece into a die, which forms the recess.

An advantageous design of the method according to the invention is that the recess, which is introduced in the lateral surface of the workpiece, when seen in the cross-section of the workpiece, is asymmetrical. In particular the recess can be asymmetrical to the radial direction of the screw. Because of the asymmetrical design, it is possible for resistance to forming to be reduced when forming the recess, without producing substantial functional losses in the finished screw.

It is especially preferred that a flank of the recess leading in the rolling rotational direction of the workpiece run more steeply with respect to the lateral surface of the workpiece than a flank of the recess trailing in the rolling rotational direction of the workpiece. The resulting asymmetric flow of material can further strengthen the effect which produces the non-round cross-section in the tip region. The rolling rotational direction of the workpiece is understood as the rotational direction in which the workpiece is put into motion by the two rolling tools during the thread rolling process.

A concrete screw according to the invention is characterized in that the shaft has a greater eccentricity in the cross-section of the shaft in a tip region than in a center region, with the tip region being located axially closer to the tip of the concrete screw than the center region. As already explained above, such a shape makes it possible to achieve a good cutting effect with low friction and thus a good insertability with simultaneously high loading capacities. For example, the shaft can have a circular cross-section in the center region and a cross-section in the tip region that approximates a spherical polygon. Eccentricity can be understood in particular as the average or maximum deviation from an ideal circular shape.

It is especially preferred that in the tip region, the shaft have an uneven number of curvature maximums in the cross-section of the shaft, in particular at least three curvature maximums, preferably precisely three curvature maximums. This can result in an especially simple fabrication in a method according to the invention. The screw preferably has an uneven number of cut-out recesses, in particular at least three cut-out recesses, preferably precisely three cut-out recesses.

It is furthermore preferred that the tip region with the greater eccentricity as opposed to the center region extends axially beyond the cut-out recess. In accordance with this embodiment, the non-round tip region extends in particular further away from the screw tip and/or further toward the screw head than the cut-out recess. This can further improve insertability. This embodiment can take into consideration that the cutting effect is frequently concentrated on the end of the cut-out recess, whereas the non-round shape can be in a position to accommodate concrete dust that accrues over its entire length.

The features cited in conjunction with the screw according to the invention can also be used in the method according to the invention, just as, conversely, features cited in conjunction with the method according to the invention can also be used in the screw according to the invention. A concrete screw according to the invention can preferably be manufactured in a method according to the invention.

If one refers to the cross-section of the shaft in conjunction with the invention, this should relate in particular to the cross-section of the shaft exclusively. The screw thread and the cut-out recess are preferably not part of the shaft in the definition of this text, in other words, the screw thread and the cut-out recess can be irrelevant within the meaning of the invention in the consideration of the shaft cross-section, and the shaft cross-section must be interpolated in these areas. A cross-section can be understood in particular as a section perpendicular to the longitudinal axis of the workpiece and/or the screw.

The invention is explained in more detail in the following on the basis of preferred exemplary embodiments, which are depicted schematically in the attached figures, wherein individual features of the exemplary embodiments shown in the following can be realized individually or in any combination in conjunction with the invention. The figures show the following schematically:

### BRIEF DESCRIPTION OF THE DRAWINGS

FIGS. 1 to 5: A workpiece in different successive stages during the fabrication sequence of a first embodiment of a method according to the invention; FIGS. 1 to 4 show side views and FIG. 5 is a perspective representation, with FIG. 5 depicting a concrete screw according to the invention as the final product;

FIG. 6: A perspective representation of the concrete screw from FIG. 5 from another angle;

FIG. 7: A perspective representation of the rolling die arrangement from FIG. 4, wherein for the sake of clarity the thickening at the end, which forms the screw head, is not shown;

FIG. 8: A schematic cross-sectional view of the rolling die arrangement from FIG. 4;

FIGS. 9 to 11: Measured cross-sections of a concrete screw, which were manufactured in a method according to the invention, at different axial positions along the shaft in order to clarify the non-round cross-section in the tip region; and

FIG. 12: Measured eccentricities of the shafts of two concrete screws over the distance from the respective screw tip, wherein the upper scatter plot with the triangle marks represent a concrete screw having three cut-out recesses, which was manufactured in a method according to the invention, and the lower scatter plot with the square marks represent a concrete screw having four cut-out recesses.

### DETAILED DESCRIPTION OF THE DRAWINGS

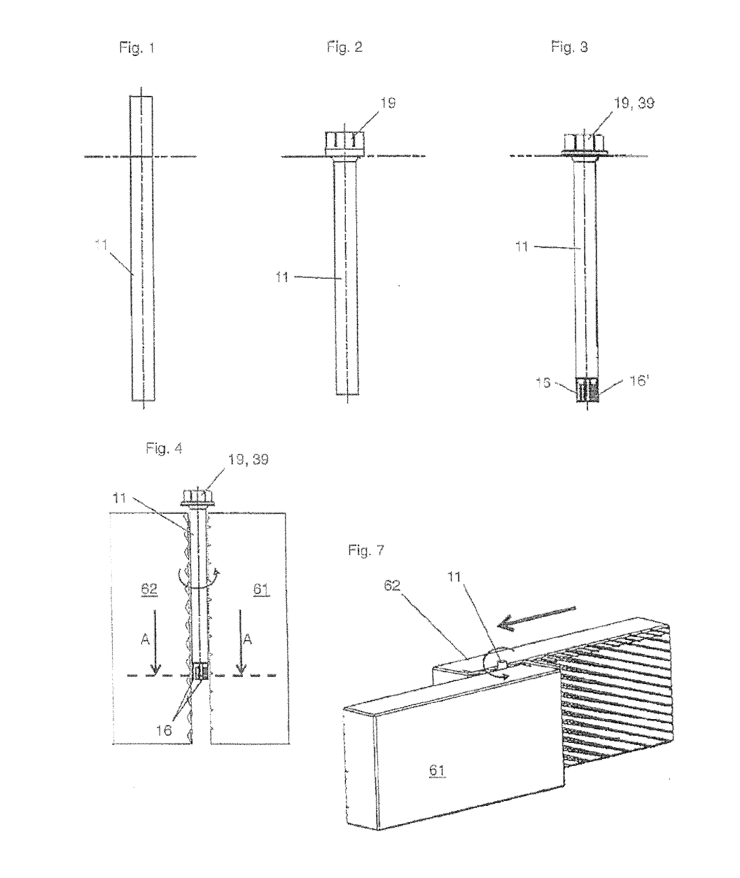

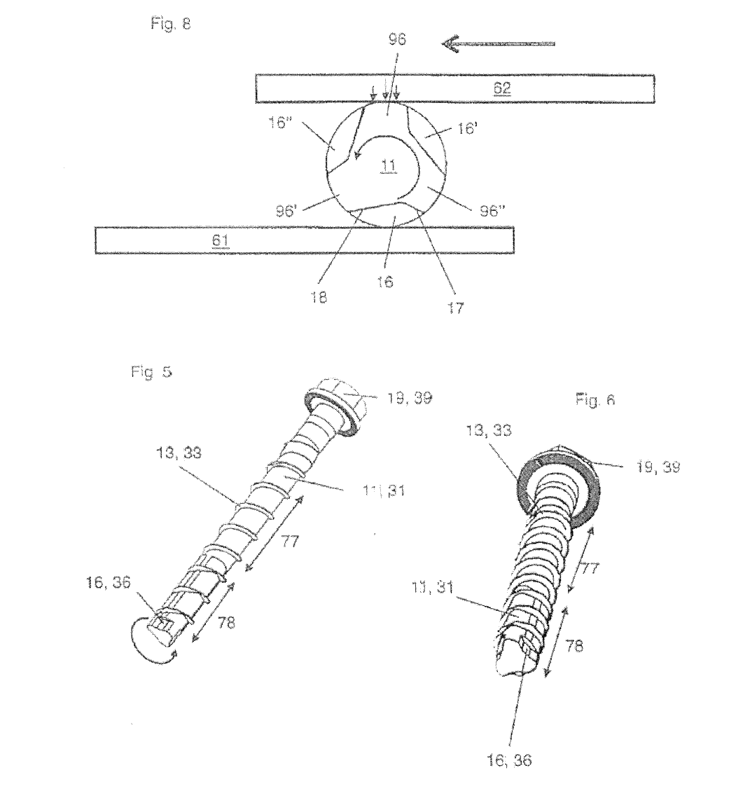

FIGS. 1 to 8 illustrate a first exemplary embodiment of a method according to the invention, wherein FIGS. 1 to 5 show a sequence of stages from the unprocessed piece of rod (FIG. 1) to the finished final product (FIG. 5).

As FIG. 1 shows, the method begins with a straight piece of a metal rod being provided as the workpiece 11.

In the subsequent step of the process, a thickening 19 with an external hexagon is compressed on an end of the workpiece 11, thereby obtaining the intermediate product shown in FIG. 2.

In the next step of the process, the thickening 19 is formed further to a screw head 39. During the same step of the process, at the end of the workpiece 11, which is opposite from the thickening 19, three recesses 16 are formed in the cylinder surface of the workpiece 11 by means of a forming process, for example by the end of the workpiece 11 that is opposite from the thickening 19 being pressed into a die. The intermediate product that is obtained hereby is depicted in FIGS. 3, 4 and 8. Three recesses 16, 16′, 16″ are provided in the present exemplary embodiment and they are arranged equidistantly in the cross-section of the shaft (cf. FIG. 8).

Then, as shown in FIGS. 4, 7 and 8, the workpiece 11 is put between two rolling tools 61 and 62, which are formed as profiled thread rolling dies. In the depicted exemplary embodiment, the first rolling tool 61 is stationary, whereas the second rolling tool 62 moves linearly in the direction of the arrow in FIG. 7. The workpiece 11 is hereby put into motion in the rolling rotational direction of the workpiece depicted with an arrow in FIGS. 4, 7 and 8.

A threaded coil 13 or even a plurality of threaded coils is formed on the cylinder surface of the workpiece 11 by means of the rolling tools 61 and 62. As FIGS. 4 and 8 in particular show, the rolling tools 61 and 62 in this case act on the area of the workpiece 11 where the recesses 16 are located. The product obtained from rolling is depicted in FIGS. 5 and 6.

The stage shown in FIGS. 5 and 6 at the same time represents the final product. In the case of the final product, i.e., the screw, the thickening 19 forms the screw head 39 and the threaded coil 13 forms the screw thread 33 of the screw. The three formed recesses 16 form three cut-out recesses 36 in the shaft 31.

As FIGS. 5 and 6 show, a screw according to the invention that has a shaft cross-section that varies along the screw can be obtained by means of the method according to the invention. In this case, the shaft 31 has a substantially circular cross-section in an axial center region 77. On the other hand, in a tip region 78 that originates from the tip of the screw and/or that is located on the side of the center region 77 opposite from the screw head 39, the shaft 31 has a non-round cross-section, in other words, the curvature of the shaft cross-sections is not constant there in the respective shaft cross-section, but changes in the circumferential direction.

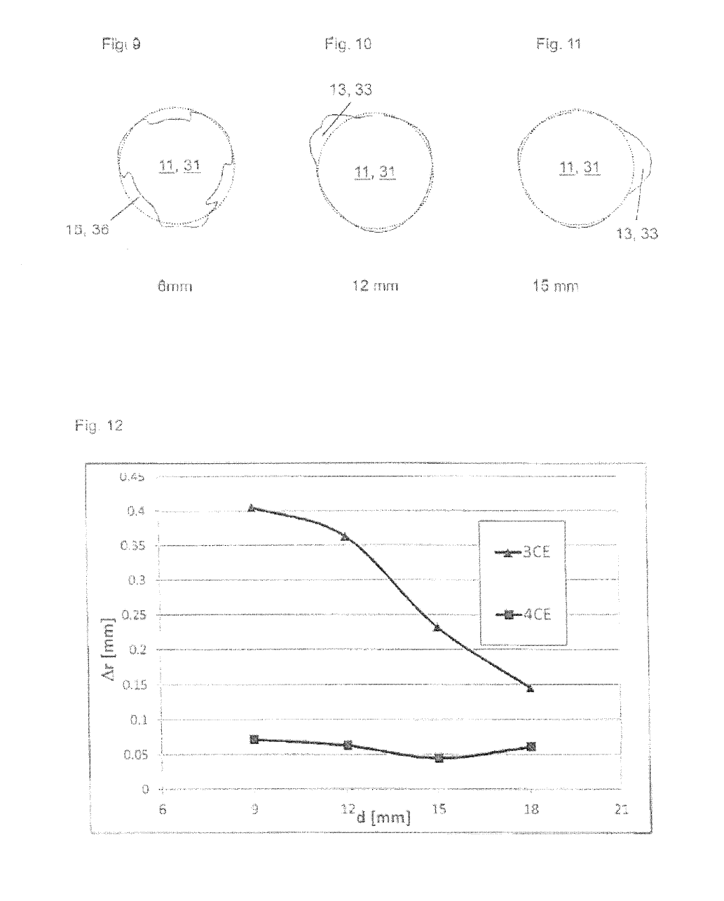

The solid lines in FIGS. 9 to 11 show shaft cross-sections in the tip region, which were measured on a real screw, and the dotted lines show a theoretical circular shape. In this case, FIG. 9 shows the cross-section at a distance of 6 mm, FIG. 10 at a distance of 12 mm and FIG. 11 at a distance of 15 mm from the tip of the screw, in other words, the section in FIG. 11 was measured closer to the screw head than the section in FIG. 9. During the production of the measured screw, three equidistantly arranged recesses 16, 16′, 16″ were introduced in the lateral surface of the workpiece 11 prior to the thread rolling step in accordance with the exemplary embodiment in FIGS. 1 to 8. As FIGS. 9 to 11 show, the measured shaft cross-section in the tip region deviates from a circular shape. There the shaft cross-section (without the screw thread and cut-out recesses) has a shape approximating a triangle, with three curvature maximums and three curvature minimums, similar to a Reuleaux triangle. This non-round shape is also found in the portion of the tip region that is so far away from the tip that cut-out recesses are no longer present there (see FIGS. 10 and 11).

The measured eccentricity Δr, i.e., the deviation from an ideal circular shape, is plotted in mm in FIG. 12 over the distance d in mm from the screw tip, and specifically first from the screw in FIGS. 9 to 11, which was fabricated with three equidistant recesses (upper scatter plot “3CE”, shown with triangle marks), and secondly, from a screw which was fabricated in an analogous manner, but with four equidistant recesses (lower scatter plot “4CE”, shown with square marks). As FIG. 12 shows, the shaft of the screw with three recesses is distinctively non-round in the tip region, and only approaches a circular cross-section with an increasing distance from the tip, whereas the screw with four recesses has an almost circular shaft cross-section throughout.

As FIGS. 10 and 11 as well as FIGS. 5 and 6 show, the tip region 78 with the non-round cross-section extends axially further towards the screw head 39 than the cut-out recesses 36.

A possible mechanism that can produce the observed locally non-round shaft shape in the case of an uneven number of recesses is evident in FIG. 8. As FIG. 8 shows, because of the equidistant arrangement and the uneven number, each of the three recesses 16, 16′ and 16″, when seen in the cross-section of the workpiece 11, is opposite from an area 96, 96′ or 96″ that is free of recesses. The momentary status in FIG. 8 shows the rolling die 62 acting on the area 96 that is free of recesses. The recess 16 is arranged in the workpiece 11 diametrically opposite from the area 96 that is free of recesses. Because of this recess 16, the opposing rolling die 61 does not produce any counter pressure, which can cause the workpiece 11 to bend on its tip downward toward the rolling die 61 thereby shifting its center. This can produce a type of wobbling motion in the tip region, which can cause the observed deformation.

As FIG. 8 shows with the example of the first recess 16, the recesses 16, 16′, 16″ in the lateral surface of the workpiece 11 can also be asymmetrical in the cross-section of the workpiece 11. In particular, the flank 17 of the first recess 16, which runs ahead in the rolling rotational direction of the workpiece, is designed to be steeper than the opposite flank 18 of the first recess 16.

The screw-in direction of the threaded coil 13 or the screw thread 33 is shown with an arrow in FIG. 5. In particular, it can be opposed to the rolling rotational direction of the workpiece during thread rolling (see arrows in FIGS. 4, 7 and 8).

1-12. (canceled)

13. A method for producing a screw, comprising the steps of:
providing a piece of a rod as a workpiece;
forming a threaded coil on a lateral surface of the workpiece in a thread rolling process in which two profiled rolling tools act on the workpiece; and
forming a recess in the lateral surface of the workpiece on an end area of the workpiece;
wherein the recess, in a cross-section of the workpiece, is diametrically opposite from an area of the workpiece that is free of a recess;
wherein initially the recess is formed in the lateral surface of the workpiece, and subsequently, the threaded coil is then formed on the lateral surface of the workpiece;
and wherein at least one of the two profiled rolling tools acts on the end area of the workpiece with the recess during the thread rolling process of the threaded coil forming step.

14. The method according to claim 13, further comprising a plurality of recesses formed in the lateral surface of the workpiece wherein the plurality of recesses is an uneven number of recesses.

15. The method according to claim 14, wherein the plurality of recesses, in the cross-section of the workpiece, are arranged equidistantly and/or wherein the workpiece has a rotationally symmetric cross-sectional shape on the plurality of recesses.

16. The method according to claim 13, wherein the thread rolling process is a flat-die rolling process in which the two profiled rolling tools, which are moved linearly, act as rolling tools on the workpiece.

17. The method according to claim 13, wherein the recess is introduced in the lateral surface of the workpiece by forming.

18. The method according to claim 13, wherein the recess is open towards a front side of the workpiece and/or wherein the recess is introduced by impact extrusion.

19. The method according to claim 13, wherein the workpiece is compressed and a thickening is thereby fabricated at an end of the screw and wherein the thickening at the end is fabricated or formed at a same time that the recess is introduced in the lateral surface of the workpiece.

20. The method according to claim 13, wherein the recess, in the cross-section of the workpiece, is asymmetrical such that a flank of the recess leading in a rolling rotational direction of the workpiece runs more steeply with respect to the lateral surface of the workpiece than a flank of the recess trailing in the rolling rotational direction.

21. A concrete screw, comprising:
a shaft; and
a screw thread arranged on a lateral surface of the shaft;
wherein a cut-out recess is disposed in the lateral surface of the shaft on a tip of the shaft;
and wherein the shaft has a greater eccentricity in a cross-section of the shaft in a tip region than in a center region, with the tip region located axially closer to the tip than the center region.

22. The concrete screw according to claim 21, wherein, in the tip region, the shaft has an uneven number of curvature maximums in the cross-section of the shaft.

23. The concrete screw according to claim 21, wherein the tip region extends axially beyond the cut-out recess.

24. The concrete screw according to claim 21, wherein the concrete screw is produced by a method according to claim 13.
